(19) United States
(12) Patent Application Publication
(10) Pub. No.: US 2014/0304548 A1
(43) Pub. Date: Oct. 9, 2014

(54) INTELLIGENT AND EFFICIENT RAID REBUILD TECHNIQUE

(71) Applicant: INTERNATIONAL BUSINESS MACHINES CORPORATION, Armonk, NY (US)

(72) Inventors: Jeffrey Raymond Steffan, San Jose, CA (US); Michael Thomas Benhase, Tucson, AZ (US); Volker Michael Kiemes, Zornheim (DE)

(73) Assignee: International Business Machines Corporation, Armonk, NY (US)

(21) Appl. No.: 13/855,775

(22) Filed: Apr. 3, 2013

(51) Int. Cl. G06F 11/10

(52) U.S. Cl. CPC G06F 11/1092
USPC 714/6.23

(57) ABSTRACT

A method for servicing a redundant array of independent storage drives (i.e., RAID) includes performing a service call on the RAID by performing the following steps: (1) determining whether the RAID includes one or more consumed spare storage drives; (2) in the event the RAID includes one or more consumed spare storage drives, physically replacing the one or more consumed spare storage drive with one or more non-consumed spare storage drives; and (3) initiating a copy process that copies data from a storage drive that is predicted to fail to a non-consumed spare storage drive associated with the RAID. The service call may then be terminated. After the service call is terminated, the method waits for an indication that a number of non-consumed spare storage drives in the RAID has fallen below a selected threshold. A corresponding apparatus and computer program product are also disclosed.

### BACKGROUND

1. Field of the Invention

This invention relates to techniques for intelligently and efficiently rebuilding redundant arrays of independent storage drives (RAIDS).

2. Background of the Invention

Redundant arrays of independent storage drives (RAIDS) are used extensively to provide data redundancy in order to protect data and prevent data loss. Various different “RAID levels” have been defined, each providing data redundancy in a different way. Each of these RAID levels provides data redundancy in a way that if one (or possibly more) storage drives in the RAID fail, data in the RAID can still be recovered.

In some cases, predictive failure analysis (PFA) may be used predict which storage drives in a RAID are going to fail. For example, events such as media errors, as well as the quantity and frequency of such events, are indicators that may be used to predict which storage drives will fail as well as when they will fail. This may allow corrective action to be taken on a RAID prior to a storage drive failure. For example, a storage drive that is predicted to fail may be removed from an array and replaced with a new drive prior to failure. Data may then be rebuilt on the new drive to restore data redundancy.

Unfortunately, PFE is not always accurate. In some cases, PFA may predict that a certain drive is going to fail when in reality a different drive fails first. In certain cases, an erroneous prediction can create situations that compromise data integrity. For example, if a drive that is predicted to fail is replaced with a new drive and, while data is being rebuilt on the new storage drive, a different drive fails, all or part of the data in the array may be permanently lost. Data loss can have mild to very severe consequences for an organization.

In view of the foregoing, what are needed are techniques to more intelligently and efficiently maintain arrays of independent storage drives (RAIDS). Ideally, in cases where a storage drive in a RAID is predicted to fail, such techniques will allow the RAID to be serviced in a way that better protects data while the RAID is being rebuilt. Ideally, such techniques will also minimize the amount of time a technician needs to service a RAID.

### SUMMARY

The invention has been developed in response to the present state of the art and, in particular, in response to the problems and needs in the art that have not yet been fully solved by currently available apparatus and methods. Accordingly, the invention has been developed to enable users to more efficiently and intelligently service redundant arrays of storage drives. The features and advantages of the invention will become more fully apparent from the following description and appended claims, or may be learned by practice of the invention as set forth hereinafter.

Consistent with the foregoing, a method for servicing a redundant array of independent storage drives (i.e., RAID) is disclosed herein. In one embodiment, such a method includes performing a service call on the RAID by performing the following steps: (1) determining whether the RAID includes one or more consumed spare storage drives; (2) in the event the RAID includes one or more consumed spare storage drives, physically replacing the one or more consumed spare storage drive with one or more non-consumed spare storage drives; and (3) initiating a copy process that copies data from a storage drive that is predicted to fail to a non-consumed spare storage drive associated with the RAID. The service call may then be terminated. After the service call is terminated, the method waits for an indication that a number of non-consumed spare storage drives in the RAID has fallen below a selected threshold.

A corresponding apparatus and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a network architecture hosting one or more storage systems;

FIG. 2 is a high-level block diagram showing one example of a storage system which may host one or more RAIDs;

FIG. 3 is a high-level block diagram showing an array of storage drives comprising multiple non-consumed spare storage drives, and an intelligent copy process that copies data from a storage drive that is predicted to fail to a non-consumed spare storage drive;

FIG. 4 is a high-level block diagram showing the array of storage drives with three non-consumed spare storage drives and one consumed spare storage drives;

FIG. 5 is a high-level block diagram showing the array of storage drives with two non-consumed spare storage drives and two consumed spare storage drives;

FIG. 6 is a high-level block diagram showing the array of storage drives after a service call has been completed on the array shown in FIG. 5, and an intelligent copy process has been initiated from a storage drive that is predicted to fail to a non-consumed spare storage drive;

FIG. 7 is a high-level block diagram showing the array of storage drives after data has been copied from the storage drive that is predicted to fail to the non-consumed spare storage drive; and

FIG. 8 is a process flow diagram showing one embodiment of a method for servicing a RAID.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As will be appreciated by one skilled in the art, the present invention may be embodied as an apparatus, system, method, or computer program product. Furthermore, the present invention may take the form of a hardware embodiment, a software embodiment (including firmware, resident software, micro-code, etc.) configured to operate hardware, or an embodiment combining software and hardware aspects that may all generally be referred to herein as a “module” or “system.” Furthermore, the present invention may take the form of a computer-usable storage medium embodied in any tangible medium of expression having computer-usable program code stored therein.

Any combination of one or more computer-usable or computer-readable storage medium(s) may be utilized to store the computer program product. The computer-usable or computer-readable storage medium may be, for example but not limited to, an electronic, magnetic, optical, electromagnetic, infrared, or semiconductor system, apparatus, or device. More specific examples (a non-exhaustive list) of the computer-readable storage medium may include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CDROM), an optical storage device, or a magnetic storage device. In the context of this document, a computer-usable or computer-readable storage medium may be any medium that can contain, store, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like, and conventional procedural programming languages, such as the “C” programming language or similar programming languages. Computer program code for implementing the invention may also be written in a low-level programming language such as assembly language.

Embodiments of the invention may be described below with reference to flowchart illustrations and/or block diagrams of methods, apparatus, systems, and computer program products. It will be understood that each block of the flowchart illustrations and/or block diagrams, and combinations of blocks in the flowchart illustrations and/or block diagrams, may be implemented by computer program instructions or code. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be stored in a computer-readable storage medium that can direct a computer or other programmable data processing apparatus to function in a particular manner, such that the instructions stored in the computer-readable storage medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

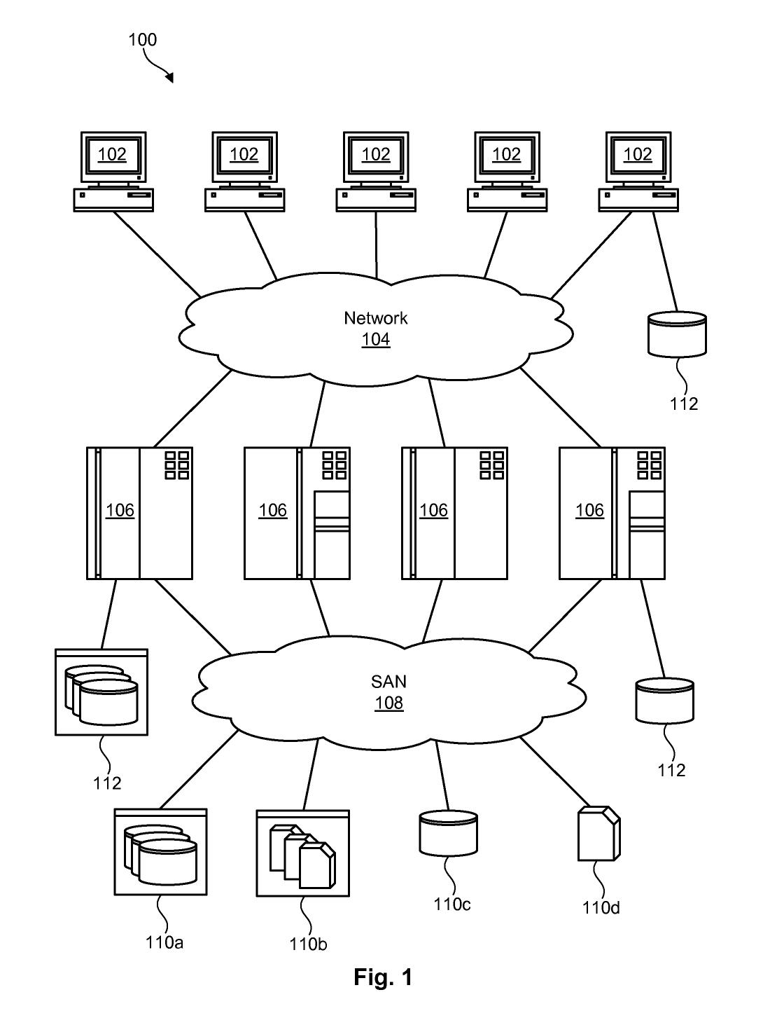

Referring to FIG. 1, one example of a network architecture 100 is illustrated. The network architecture 100 is presented to show one example of an environment where embodiments of the invention might operate. The network architecture 100 is presented only by way of example and not limitation. Indeed, the apparatus and methods disclosed herein may be applicable to a wide variety of different network architectures in addition to the network architecture 100 shown.

As shown, the network architecture 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “hosts” 106 or “host systems” 106). In general, the client computers 102 initiate communication sessions, whereas the server computers 106 wait for requests from the client computers 102. In certain embodiments, the computers 102 and/or servers 106 may connect to one or more internal or external direct-attached storage systems 112 (e.g., arrays of hard-storage drives, solid-state drives, tape drives, etc.). These computers 102, 106 and direct-attached storage systems 112 may communicate using protocols such as ATA, SATA, SCSI, SAS, Fibre Channel, or the like.

The network architecture 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems 110, such as arrays 110a of hard-disk drives or solid-state drives, tape libraries 110b, individual hard-disk drives 110c or solid-state drives 110c, tape drives 110d, CD-ROM libraries, or the like. To access a storage system 110, a host system 106 may communicate over physical connections from one or more ports on the host 106 to one or more ports on the storage system 110. A connection may be through a switch, fabric, direct connection, or the like. In certain embodiments, the servers 106 and storage systems 110 may communicate using a networking standard such as Fibre Channel (FC) or iSCSI.

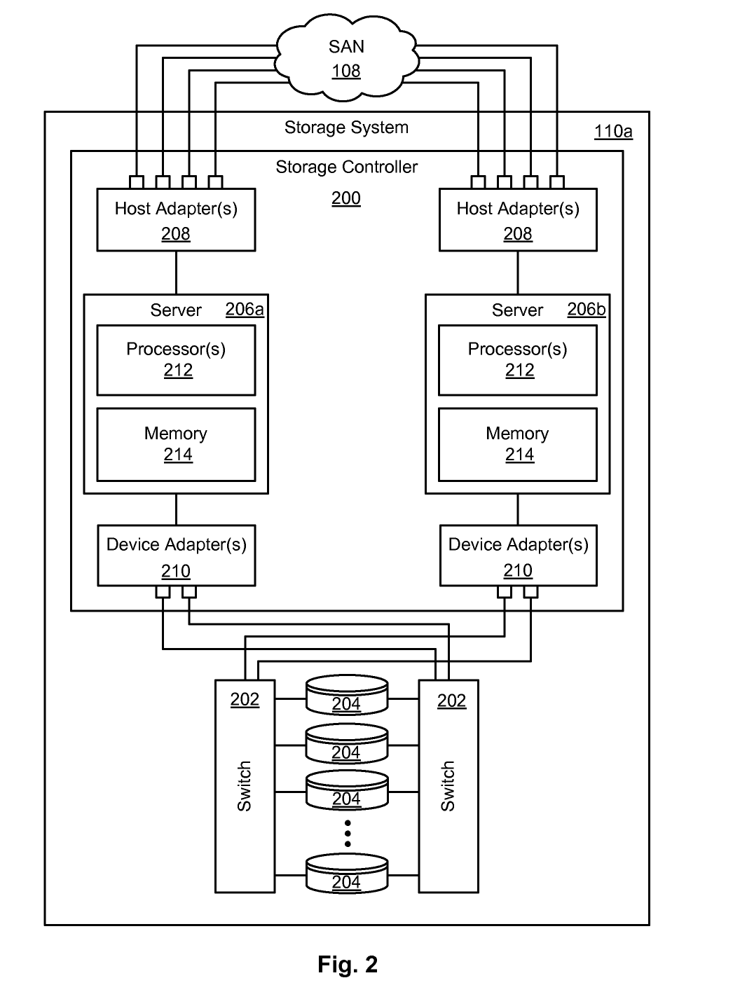

Referring to FIG. 2, one example of a storage system 110a containing an array of hard-disk drives 204 and/or solid-state drives 204 is illustrated. The internal components of the storage system 110a are shown since the techniques disclosed herein may, in certain embodiments, be implemented within such a storage system 110a, although the techniques may also be applicable to other storage systems 110. As shown, the storage system 110a includes a storage controller 200, one or more switches 202, and one or more storage drives 204, such as hard-disk drives 204 and/or solid-state drives 204 (e.g., flash-memory-based drives 204). The storage controller 200 may enable one or more hosts 106 (e.g., open system and/or mainframe servers 106) to access data in the one or more storage drives 204.

In selected embodiments, the storage controller 200 includes one or more servers 206. The storage controller 200 may also include host adapters 208 and device adapters 210 to connect the storage controller 200 to host devices 106 and storage drives 204, respectively. Multiple servers 206a, 206b may provide redundancy to ensure that data is always available to connected hosts 106. Thus, when one server 206a fails, the other server 206b may pick up the I/O load of the failed server 206a to ensure that I/O is able to continue between the hosts 106 and the storage drives 204. This process may be referred to as a “failover.”

In selected embodiments, each server 206 may include one or more processors 212 and memory 214. The memory 214 may include volatile memory (e.g., RAM) as well as non-volatile memory (e.g., ROM, EPROM, EEPROM, hard disks, flash memory, etc.). The volatile and non-volatile memory may, in certain embodiments, store software modules that run on the processor(s) 212 and are used to access data in the storage drives 204. The servers 206 may host at least one instance of these software modules. These software modules may manage all read and write requests to logical volumes in the storage drives 204.

One example of a storage system 110a having an architecture similar to that illustrated in FIG. 2 is the IBM DS8000™ enterprise storage system. The DS8000™ is a high-performance, high-capacity storage controller providing disk and solid-state storage that is designed to support continuous operations. Nevertheless, the methods disclosed herein are not limited to the IBM DS8000™ enterprise storage system 110a, but may be implemented in any comparable or analogous storage system 110, regardless of the manufacturer, product name, or components or component names associated with the system 110. Any storage system that could benefit from one or more embodiments of the invention is deemed to fall within the scope of the invention. Thus, the IBM DS8000™ is presented only by way of example and not limitation.

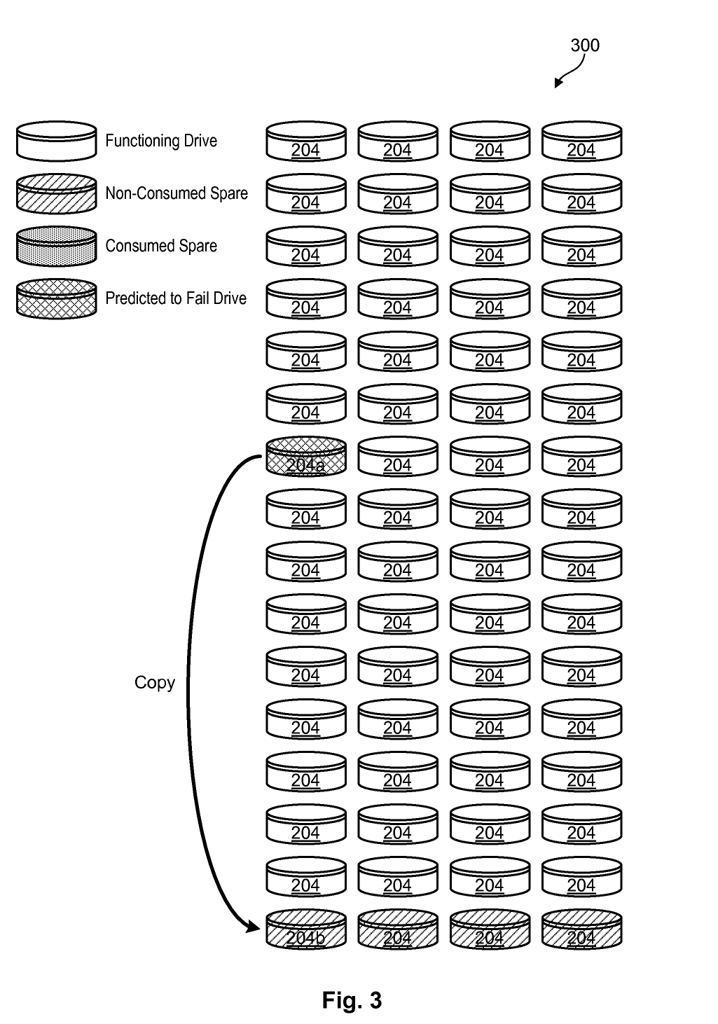

Referring to FIG. 3, a high-level block diagram showing an array 300 of storage drives 204 is illustrated. Such an array 300 may be included in a storage system 110 such as that illustrated and described in associated with FIG. 2. In this embodiment, the array 300 includes sixty-four storage drives 204, although this number is not limiting. Any other number of storage drives 204 could be included in the array 300. The storage drives 204 within the array 300 may be organized into one or more RAIDs of any RAID level. For example, some storage drives 204 in the array 300 could be organized into a RAID 0 array while other storage drives 204 could be organized into a RAID 5 array. The number of storage drives 204 within each RAID array may also vary as known to those of skill in the art.

As can be appreciated, organizing storage drives 204 into a RAID provides data redundancy that allows data to be preserved in the event one (or possibly more) storage drives 204 within the RAID fails. In a conventional RAID rebuild, when a drive 204 in a RAID fails, the failing drive 204 is replaced with a new drive 204 and data is then reconstructed on the new drive 204 using the data on the RAID's other drives 204. This rebuild process restores data redundancy in the RAID. Although usually effective, such a conventional RAID rebuild process has various pitfalls. For example, if another storage drive 204 were to fail while the already failed drive 204 is being rebuilt, all or part of the data in the RAID may be lost.

In order to prevent or reduce the chance of permanent data loss, a more intelligent RAID rebuild process using predictive failure analysis (PFA) may be used. As previously mentioned, by analyzing events such as media errors, PFA may be used predict if and when a storage drive 204 is going to fail. This may allow corrective action to be taken prior to the storage drive's failure. Instead of rebuilding data on a failing storage drive 204 from data on other drives 204 in the RAID, the data on the failing storage drive 204 may be copied to a spare storage drive 204 prior to its failure. For example, FIG. 3 shows an intelligent rebuild process wherein data is copied from a storage drive 204a that is predicted to fail to a non-consumed spare storage drive 204b in the array 300. This technique has the advantage that it maintains full RAID data protection during the rebuild process. Thus, if another drive 204 were to fail during the rebuild process, data integrity would be preserved. This technique will be referred to hereinafter as an “intelligent RAID rebuild” or “intelligent rebuild process.”

Unfortunately, for a technician who is servicing a RAID, the intelligent rebuild process can consume additional time, potentially increasing costs. For example, using a conventional RAID rebuild process, a technician may physically pull a failing drive 204 from the RAID array and insert a new good drive 204. The data may then be rebuilt on the new drive 204 using data from the other good drives 204 in the RAID, thereby restoring data redundancy. Because the failed drive 204 has been removed from the RAID array, the technician can terminate the service call and physically leave the site. Using an intelligent rebuild process, however, the failing drive 204 must be left in the array until its data is copied to a new drive 204. This copy process can last a significant amount of time, possibly several hours. In some cases, a technician may need to wait for this process to complete prior to terminating the service call and physically leaving the site of the array so that the failing drive 204 can be pulled from service. As previously mentioned, this additional time can drive up service costs.

As will be explained in more detail hereafter, embodiments of the invention may provide the data-protection advantages of the intelligent rebuild process, while still providing the time-savings associated with conventional RAID rebuild processes. Embodiments of the invention rely on the fact that the array 300 may include one or more spare storage drives 204 (i.e., “non-consumed spares”) that may be used for deferred maintenance purposes. When additional drives 204 are needed in the array 300, the non-consumed spares 204 may be utilized, thereby reducing the need for a technician to physically visit the site where the array 300 is located and replace failed or failing drives 204. When a number of non-consumed spares 204 has fallen below a specified level (e.g., two), a technician may visit the site to replace consumed spares 204 with non-consumed spares 204 and/or provide other maintenance.

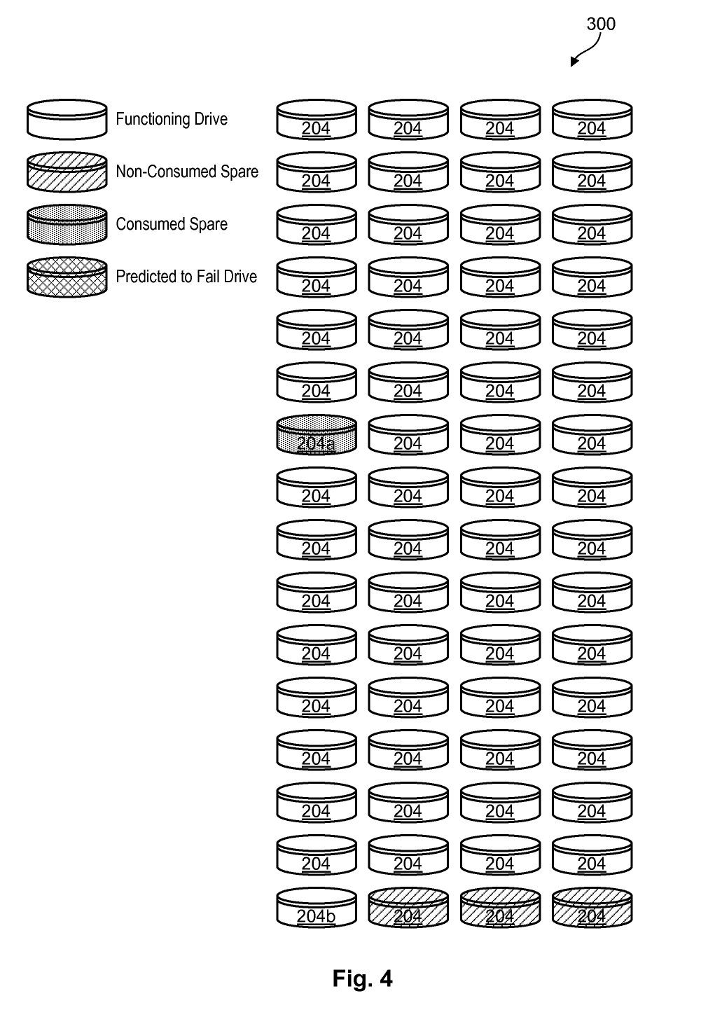

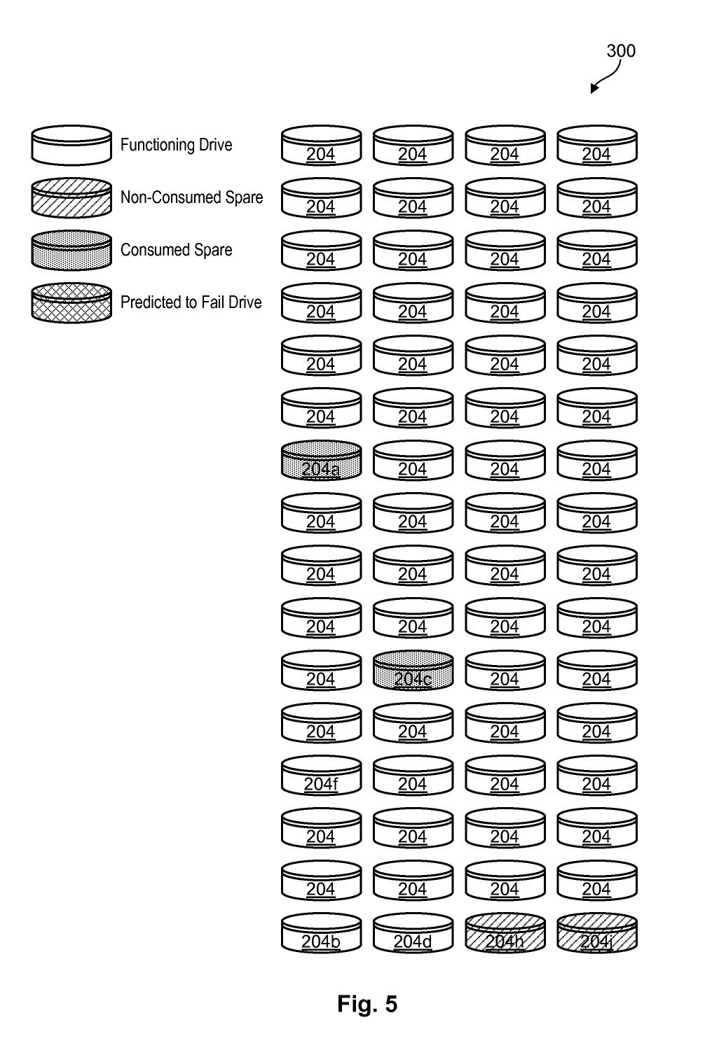

As shown in FIG. 3, when a storage drive 204a is predicted to fail, an intelligent rebuild process copies data from the failing storage drive 204a to a non-consumed spare 204b. As shown in FIG. 4, after the data is copied, the failing storage drive 204a may be retired (thereby becoming a “consumed spare” 204a) and the non-consumed spare 204b to which the data is copied becomes a functioning storage drive 204b (i.e., functioning as part of the RAID in place of the failing drive 204a). Similarly, as shown in FIG. 5, if another drive 204c is predicted to fail, the data is this failing drive may be copied to another non-consumed storage drive 204d. The failing storage drive 204c may then be retired (thereby becoming a “consumed spare” 204c) and the non-consumed spare 204d to which the data is copied becomes a functioning storage drive 204d. In the illustrated embodiment, after two non-consumed spares 204b, 204d are converted to functioning drives 204b, 204d, two non-consumed spares 204h, 204j remain. The two failing or failed drives 204a, 204c become “consumed spares” 204a, 204c.

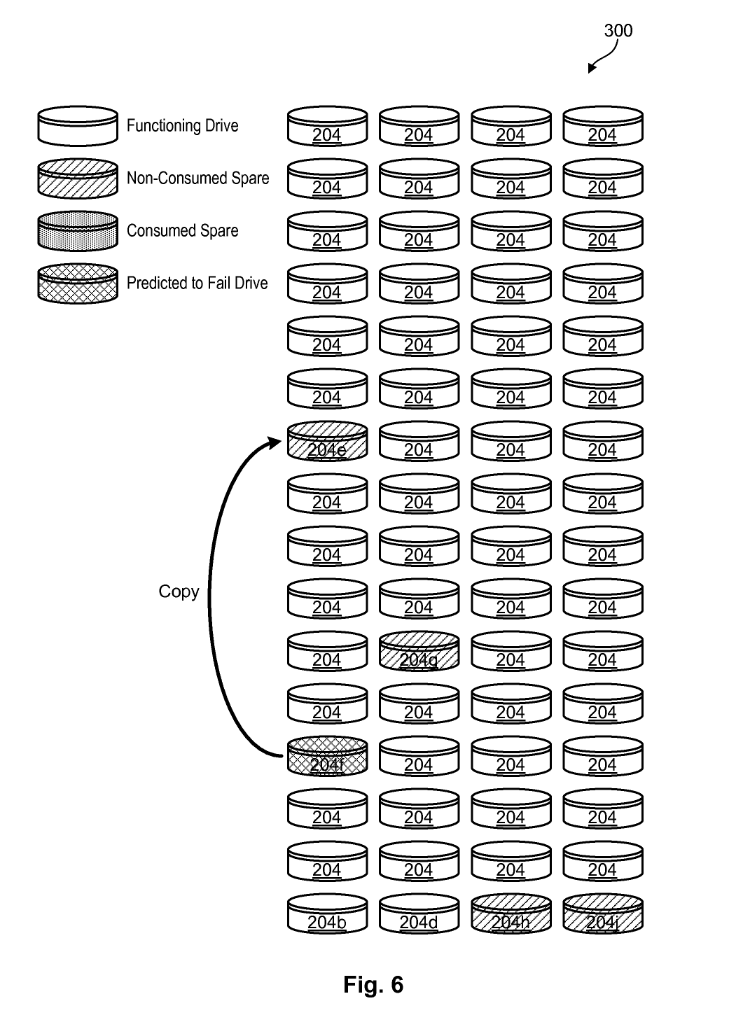

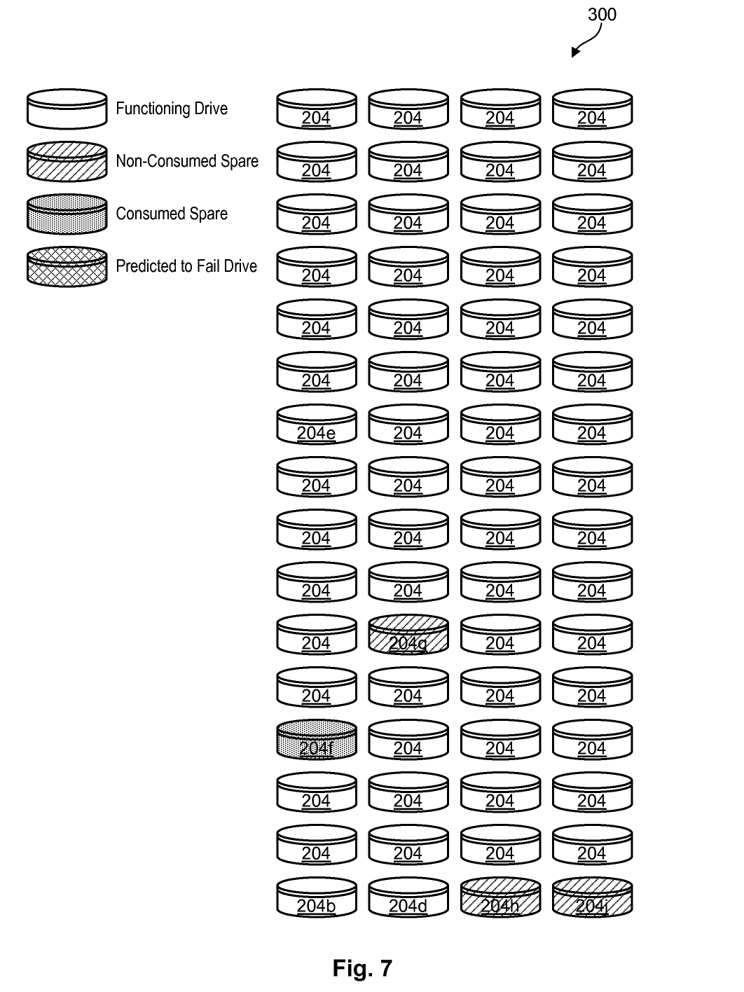

Referring to FIG. 6, assume that a storage drive 204f is predicted to fail and a technician is called to service the array 300. Upon arriving at the site, the technician may replace the “consumed spares” 204a, 204c with “non-consumed spares” 204e, 204g to fully replenish the array 300 in accordance with a deferred maintenance specification. The technician may then initiate an intelligent RAID rebuild process wherein data is copied from the drive 204f that is predicted to fail to a non-consumed spare 204e, as shown in FIG. 6. Instead of waiting for the copy to complete and removing the failing storage drive 204f, the technician may leave the site without waiting for the copy to complete (assuming that the technician has completed any other necessary maintenance). That is, the copy process may continue even after the service call is terminated. Once the copy process is complete, the non-consumed spare 204e to which the data is copied transitions to a functioning drive 204e (thereby participating in the RAID in place of the failing drive 204f) and the failing drive 204f transitions to a consumed spare 204f, as shown in FIG. 7. By allowing the intelligent rebuild process to complete after the technician has terminated the service call and leaves the site, full RAID protection is maintained while minimizing technician service time.

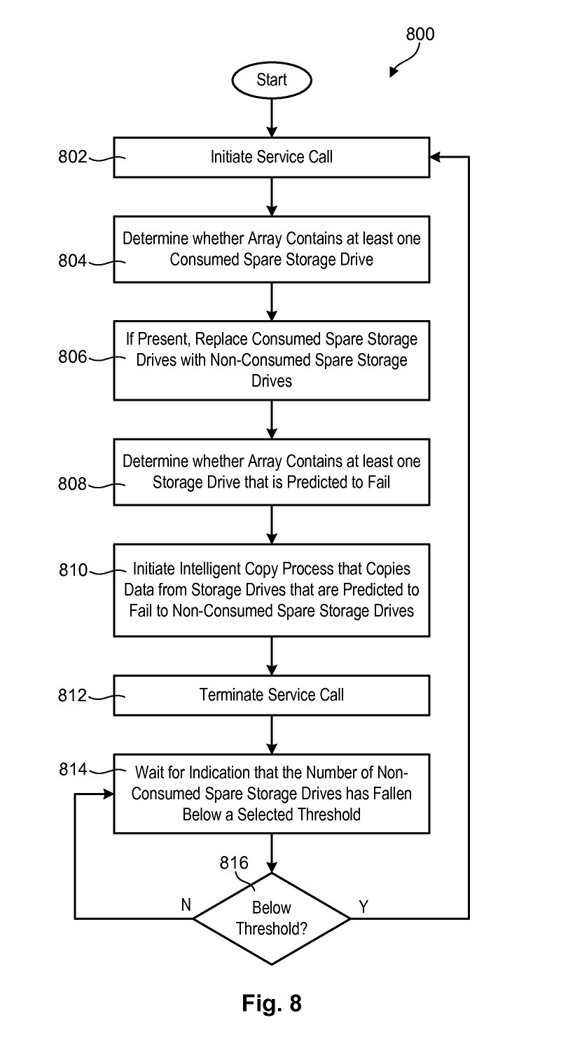

Referring to FIG. 8, one embodiment of a method 800 for servicing a RAID is illustrated. As shown, the method 800 initially initiates 802 a service call. The service call may be initiated 802 for various reasons. For example, the service call may be initiated 802 because a storage drive 204 is predicated to fail, a storage drive 204 has already failed, and/or a number of non-consumed spare storage drives 204 has fallen below a threshold, among other reasons. The method 800 may then determine 804 whether the array 300 contains one or more consumed spare storage drives 204. If one or more consumed spare storage drives 204 are present, a technician may physically replace 806 the consumed spare storage drives 204 with a corresponding number of non-consumed spare storage drives 204.

The method 800 then determines 808 whether the array 300 contains at least one storage drive 204 that is predicted to fail, but has not already failed. If so, a technician may initiate 810 an intelligent RAID rebuild process that copies from the storage drives 204 that are predicted to fail to non-consumed spare storage drives 204. At this point, the technician may terminate 812 the service call. Terminating the service call 812 may include terminating the service call 812 prior to the completion of the intelligent RAID rebuild process initiated at step 810. Once the service call is terminated, the method 800 may wait 814 for an indication (such as a “call home” event or other event monitored at a remote site) that a number of non-consumed spare storage drives 204 has fallen below a selected threshold (e.g., two). If, at step 816, the number of non-consumed spare storage drives 204 is below the threshold, a new service call may be initiated 802 to replace the consumed spare storage drives 204 with non-consumed spare storage drives 204 and/or perform other maintenance.

The method 800 illustrated in FIG. 8 is provided by way of example and not limitation. In alternative embodiments, various method steps may be deleted from the method 800, or additional steps may be added. The order of the method steps may also vary in different embodiments. For example, in certain embodiments, certain method steps (e.g., steps 804, 808) may be performed prior to initiating 802 the service call. It should also be recognized that the various method steps may be performed by different actors. For example, some method steps (e.g., steps 804, 808, 810, 814, 816, etc.) may be performed by a computing system (e.g., a hardware management console or the like) while other method steps (e.g., steps 806, 810) may be performed by a service technician who is conducting a service call. Thus, the actors that perform the various method steps may vary in different embodiments.

The method steps may, in certain embodiments, be performed as part of a “guided maintenance” process. Such guided maintenance may provide assistance to a technician in performing a service call. For example, a technician may physically visit a site hosting an array 300 and a computing system such as a hardware management console may lead the technician through a series of steps to service the array 300. In certain cases, the hardware management console may request that a technician confirm that various steps (e.g., physically replacing drives) have been completed so that new steps (e.g., intelligent RAID rebuild processes, etc.) can be performed. The technician may also initiate different processes (e.g., intelligent RAID rebuild processes, conventional RAID rebuild processes, drive replacement, etc.) by way of the hardware management console.

The flowcharts and block diagrams in the Figures illustrate the architecture, functionality, and operation of possible implementations of systems, methods, and computer-usable media according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for servicing a redundant array of independent storage drives (i.e., RAID), the RAID comprising a storage drive that is predicted to fail, the method comprising:
performing a service call on the RAID, wherein performing the service call comprises: (1) determining whether the RAID comprises at least one consumed spare storage drive; (2) in the event the RAID comprises at least one consumed spare storage drive, physically replacing the at least one consumed spare storage drive with at least one non-consumed spare storage drive; and (3) initiating a copy process that copies data from the storage drive that is predicted to fail to a non-consumed spare storage drive;
terminating the service call; and
after the service call has been terminated, waiting for an indication that a number of non-consumed spare storage drives in the RAID has fallen below a selected threshold.

2. The method of claim 1, further comprising, after the data has been copied from the storage drive that is predicted to fail to the non-consumed spare storage drive, logically replacing the storage drive that is predicted to fail with the spare storage drive that has received the copied data.

3. The method of claim 1, further comprising, in the event the number of non-consumed spare storage drives in the RAID has fallen below the selected threshold, initiating a new service call.

4. The method of claim 1, further comprising, in the event a storage drive in the RAID fails other than the storage drive that is predicted to fail, rebuilding the RAID using a conventional RAID rebuild process.

5. The method of claim 1, wherein terminating the service call comprises terminating the service call before the copy process has completed.

6. The method of claim 1, wherein terminating the service call comprises physically leaving a site where the RAID is located.

7. The method of claim 1, wherein waiting for an indication comprises waiting for a remote notification that the number of non-consumed spare storage drives in the RAID has fallen below the selected threshold.

8. An apparatus for servicing a redundant array of independent storage drives (i.e., RAID), the RAID comprising a storage drive that is predicted to fail, the apparatus comprising:
at least one processor;
at least one memory device coupled to that at least one processor and storing instructions for execution on the at least one processor, the instructions causing the at least one processor to:
provide assistance to perform a service call on the RAID, wherein providing assistance comprises: (1) determining whether the RAID comprises at least one consumed spare storage drive; (2) in the event the RAID comprises at least one consumed spare storage drive, instructing a technician to physically replace the at least one consumed spare storage drive with at least one non-consumed spare storage drive; and (3) initiating a copy process that copies data from the storage drive that is predicted to fail to a non-consumed spare storage drive;
terminate the service call; and
after the service call has been terminated, send a notification in the event a number of non-consumed spare storage drives in the RAID has fallen below a selected threshold.

9. The apparatus of claim 8, wherein the instructions further cause the at least one processor to, after the data has been copied from the storage drive that is predicted to fail to the non-consumed spare storage drive, logically replace the storage drive that is predicted to fail with the spare storage drive that has received the copied data.

10. The apparatus of claim 8, wherein the instructions further cause the at least one processor to, in the event the number of non-consumed spare storage drives in the RAID has fallen below the selected threshold, provide assistance for a technician to perform a new service call.

11. The apparatus of claim 8, wherein the instructions further cause the at least one processor to, in the event a storage drive in the RAID fails other than the storage drive that is predicted to fail, rebuild the RAID using a conventional RAID rebuild process.

12. The apparatus of claim 8, wherein terminating the service call comprises allowing a technician to terminate the service call before the copy process has completed.

13. The apparatus of claim 8, wherein terminating the service call comprises allowing a technician to physically leave a site where the RAID is located.

14. A computer program product for servicing a redundant array of independent storage drives (i.e., RAID), the RAID comprising a storage drive that is predicted to fail, the computer program product comprising a computer-readable storage medium having computer-usable program code embodied therein, the computer-usable program code comprising:
computer-usable program code to provide assistance to perform a service call on the RAID, wherein providing assistance comprises: (1) determining whether the RAID comprises at least one consumed spare storage drive; (2) in the event the RAID comprises at least one consumed spare storage drive, instructing a technician to physically replace the at least one consumed spare storage drive with at least one non-consumed spare storage drive; and (3) initiating a copy process that copies data from the storage drive that is predicted to fail to a non-consumed spare storage drive;
computer-usable program code to allow the technician to terminate the service call; and
computer-usable program code to, after the service call has been terminated, send a notification in the event a number of non-consumed spare storage drives in the RAID has fallen below a selected threshold.

15. The computer program product of claim 14, further comprising computer-usable program code to, after the data has been copied from the storage drive that is predicted to fail to the non-consumed spare storage drive, logically replace the storage drive that is predicted to fail with the spare storage drive that has received the copied data.

16. The computer program product of claim 14, further comprising computer-usable program code to, in the event the number of non-consumed spare storage drives in the RAID has fallen below the selected threshold, provide assistance for a technician to perform a new service call.

17. The computer program product of claim 14, further comprising computer-usable program code to, in the event a storage drive in the RAID fails other than the storage drive that is predicted to fail, rebuild the RAID using a conventional RAID rebuild process.

18. The computer program product of claim 14, wherein terminating the service call comprises allowing a technician to terminate the service call before the copy process has completed.

19. The computer program product of claim 14, wherein terminating the service call comprises allowing a technician to physically leave a site where the RAID is located.
